(19) United States
(12) Patent Application Publication
(10) Pub. No.: US 2009/0288057 A1
(43) Pub. Date: Nov. 19, 2009

(54) System and Method for Ordering the Selection of Integrated Circuit Chips

(75) Inventors: Rex W. Pirkle, Denison, TX (US); Sean M. Malolepszy, Sherman, TX (US); Adam R. Pirkle, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/120,695

(22) Filed: May 15, 2008

(51) Int. Cl. G06F 17/50

(52) U.S. Cl. 716/16

(57) ABSTRACT

A routing engine for use with a mounter having a chip selector and a method of routing a chip selector of a mounter. In one embodiment, the routing engine includes: (1) a memory configured to receive and store an electronic wafer map that contains coordinates and characterizations of chips of a particular wafer and (2) a travel path generator associated with the memory and configured to employ a heuristic analysis routine to generate a non-raster travel path for the chip selector to traverse with respect to the particular wafer that is shorter than a serpentine raster travel path.

### TECHNICAL FIELD OF THE DISCLOSURE

The present disclosure is directed, in general, to integrated circuit (IC) packaging and, more specifically, to a system and method for ordering the selection of IC chips.

### BACKGROUND OF THE DISCLOSURE

In state-of-art integrated circuit (IC) packaging and assembly, a serial number uniquely identifies each finished wafer in a given lot, and each serial number has associated with it an electronic wafer map. By reference to a fixed origin on the wafer, the electronic wafer map details the (e.g., Cartesian) coordinates of every “good” chip on the wafer that passed testing and should be used. Excluded from the electronic wafer map are the coordinates of every “bad” chip on the wafer that failed testing and should not be used.

In a typical chip separation (or “singulation”) operation, a tested wafer is prepared for separation by affixing it to adhesive tape stretched over a metal frame. Chips are then singulated by sawing through scribe lines that lie between rows and columns of the chips. Cleaned and readied for mounting, the separated chips remain affixed to the adhesive tape and the frame. Moved to a mounting station, the frame is fastened to a movable table (often called an “X-Y-table”) of a mounter. The table indexes the frame into the proper position during the mounting of each chip. A chip selector, which may include a vacuum pencil, of the mounter transfers each “good” chip for mounting. If the mounting involves packaging, the mounter transfers each “good” chip to a leadframe strip, which is then transported to a wire-bonder. Each device is then encapsulated and trim-formed into a finished IC package. If the mounting involves readying the chips for a tape and reel operation, the mounter transfers each “good” chip to an adhesive tape strip in a line such that the tape strip can be wound on a reel and used in a later assembly process. Although conventional mounters provide acceptable results, improvements and greater speed in mounter operation would be beneficial.

### SUMMARY OF THE DISCLOSURE

One aspect of the invention provides a routing engine for use with a mounter having a chip selector. In one embodiment, the routing engine includes: (1) a memory configured to receive and store an electronic wafer map that contains coordinates and characterizations of chips of a particular wafer and (2) a travel path generator associated with the memory and configured to employ a heuristic analysis routine to generate a non-raster travel path for the chip selector to traverse with respect to the particular wafer that is shorter than a serpentine raster travel path.

Another aspect of the invention provides a method of routing a chip selector of a mounter. In one embodiment, the method includes: (1) storing an electronic wafer map in a memory, the electronic wafer map containing coordinates and characterizations of chips of a particular wafer and (2) employing a heuristic analysis routine to generate a non-raster travel path for the chip selector to traverse with respect to the particular wafer that is shorter than a serpentine raster travel path.

Yet another aspect of the invention provides a mounter. In one embodiment, the mounter includes: (1) an X-Y-table, (2) a table actuator coupled to the X-Y-table, (3) a chip selector, (4) a chip selector actuator coupled to the chip selector and (5) a mounter controller, coupled to the table actuator and the chip selector actuator and including a routing engine, having: (5a) a memory configured to receive and store an electronic wafer map that contains Cartesian coordinates and characterizations of chips of a particular wafer and (5b) a travel path generator associated with the memory and configured to employ a heuristic analysis routine to generate a non-raster travel path for the chip selector to traverse with respect to the particular wafer that is shorter than a serpentine raster travel path.

### BRIEF DESCRIPTION OF THE DRAWINGS

For a more complete understanding of the present disclosure, reference is now made to the following descriptions taken in conjunction with the accompanying drawings, in which:

FIG. 1A is a block diagram of one embodiment of a mounter;

FIG. 1B is a block diagram of one embodiment of a mounter controller of the mounter of FIG. 1A;

FIG. 2 is a schematic diagram of one embodiment of a wafer containing “good” and “bad” chips;

FIG. 3 is a schematic diagram of a prior art serpentine raster travel path traversed by a chip selector with respect to the wafer of FIG. 2;

FIG. 4 is a schematic diagram of one example of a non-raster travel path generated in a routing engine of the mounter controller of FIG. 1B; and

FIG. 5 is a flow diagram of one embodiment of a method of routing a chip selector of a mounter.

### DETAILED DESCRIPTION

Disclosed herein is an optimization method of improving production throughput, realized by reducing cycle time inefficiencies that occur in chip mounting during IC package assembly or tape and reel operations. Embodiments of the disclosure provide enhanced performance over existing chip mounting processes, which employ a serpentine raster travel path. These embodiments substantially reduce overall chip selector travel distance and therefore travel time.

Travel distance is reduced by employing a heuristic analysis routine. The routine takes different forms in various embodiments, but may be based on the classical “Traveling Salesman Problem” (TSP), which provides a non-raster travel path, according to which coordinates of chips are reordered into a non-raster travel path that is shorter than the serpentine raster travel path. The non-raster travel path that results from the heuristic typically traverses each chip location only once and then returns to its starting position.

As those skilled in the pertinent art understand, the TSP is NP-hard, which means that an optimal solution for a given set of cities (i.e., chips) takes impractically long to compute in a typical commercial IC production environment. On the other hand, known heuristics can be employed to generate a suboptimal solution that, while less advantageous (i.e., of greater path length) than the optimal solution, is nonetheless close and quite suitable for practical applications.

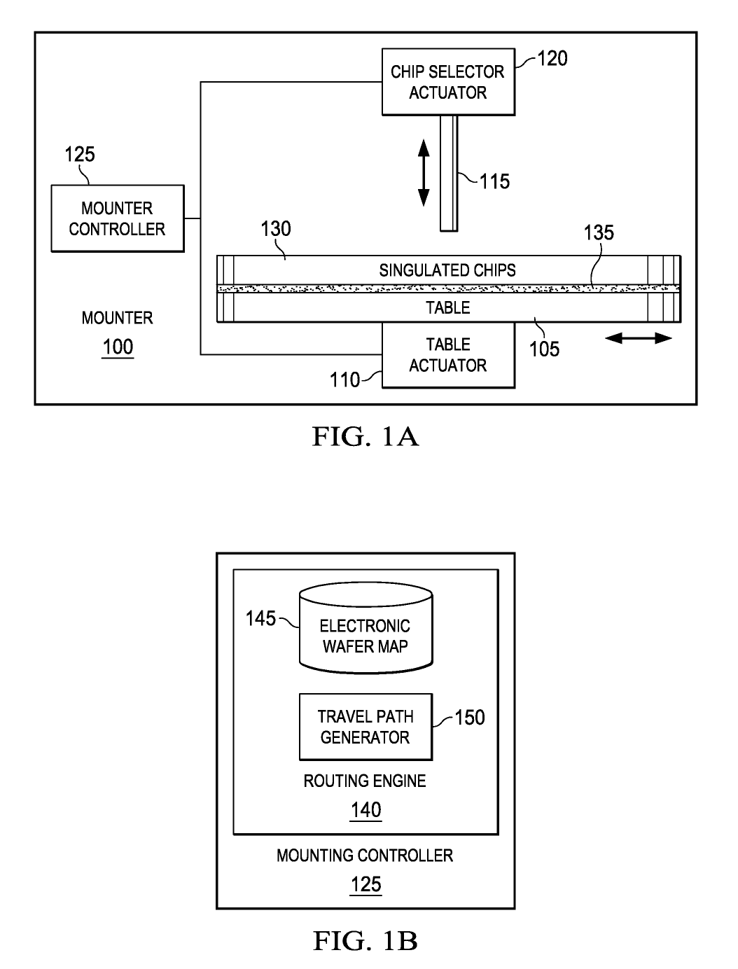

FIG. 1A is a block diagram of one embodiment of a mounter 100. The mounter 100 includes a table 105, which is capable of translating laterally in two dimensions. For this reason, the table 105 is typically called an X-Y table. An unreferenced, horizontal, double-headed arrow proximate the table 105 in FIG. 1A indicates one of the two dimensions. A table actuator 110 causes the table 105 to translate. A chip selector 115, which may take the form of a robotic arm or assembly and often fitted with a vacuum pencil (not shown), is capable of at least translation toward and away from the table 105. An unreferenced, vertical, double-headed arrow proximate the chip selector 115 in FIG. 1A indicates this. A chip selector actuator 120 causes the chip selector 115 to translate so and may further cause the chip selector to move in other directions as a particular mounter 100 may provide. A mounter controller 125 is coupled to the table actuator 110 and the chip selector actuator 120 and coordinates their operation. Accordingly, to mount a particular singulated chip (e.g., package or transfer to an adhesive tape strip), the mounter controller 125 causes the table actuator 110 to translate the table 105 such that coordinates corresponding to the particular chip are aligned with the chip selector 115. Then the mounter controller 125 causes the chip selector actuator 120 to move the chip selector 115 toward the table 135 to contact and remove the selected chip. The mounter controller 125 then repeats this process for each chip to be mounted.

In an alternative embodiment, the table 105 does not translate. Instead, the chip selector actuator 120 translates the chip selector 115 to align the coordinates corresponding to a particular chip with the chip selector 115. In another alternative embodiment, both the table 105 and the chip selector 120 translate, perhaps to increase the overall speed of the mounter 100.

FIG. 1A shows a wafer of singulated chips 130 on the table 105. As previously described, adhesive tape and a frame 135 retain the singulated chips in relative position to each other and the table 105. Mounting the chips involves removing the chips from the adhesive tape and either placing them on a lead frame strip for packaging or an adhesive tape strip such that the tape strip can be wound on a reel and used in a later assembly process.

FIG. 1B is a block diagram of one embodiment of the mounter controller 125. The mounter controller 125 typically includes a general-purpose digital computer (not shown) having memory (often including both volatile and nonvolatile portions) that stores software instructions and data and a processor that executes the instructions to manipulate the data (e.g., to calculate a shorter travel path) or produce control signals (e.g., to drive the table actuator 110 or the chip selector actuator 120 of FIG. 1A).

A routing engine 140 is enabled in the mounter controller 125. In the illustrated embodiment, the routing engine 140 is embodied in a sequence of software instructions executable in the mounter controller 125. The illustrated embodiment employs a memory 145 in the mounter controller to receive and store an electronic wafer map that contains coordinates and characterizations of chips (e.g., “good” and “bad”) of a particular wafer. The illustrated embodiment further includes a travel path generator 150 coupled to the memory 145. The travel path generator 150 is configured to employ a heuristic analysis routine to generate a non-raster travel path for the chip selector 115 of FIG. 1A that is shorter than a serpentine raster travel path. The travel path generator 150 does so by applying a heuristic analysis process to place the coordinates of the “good” chips of the wafer in an order such that visiting each chip in that order reduces the length of the path that the chip selector 115 of FIG. 1A must traverse relative to the wafer of singulated chips 130.

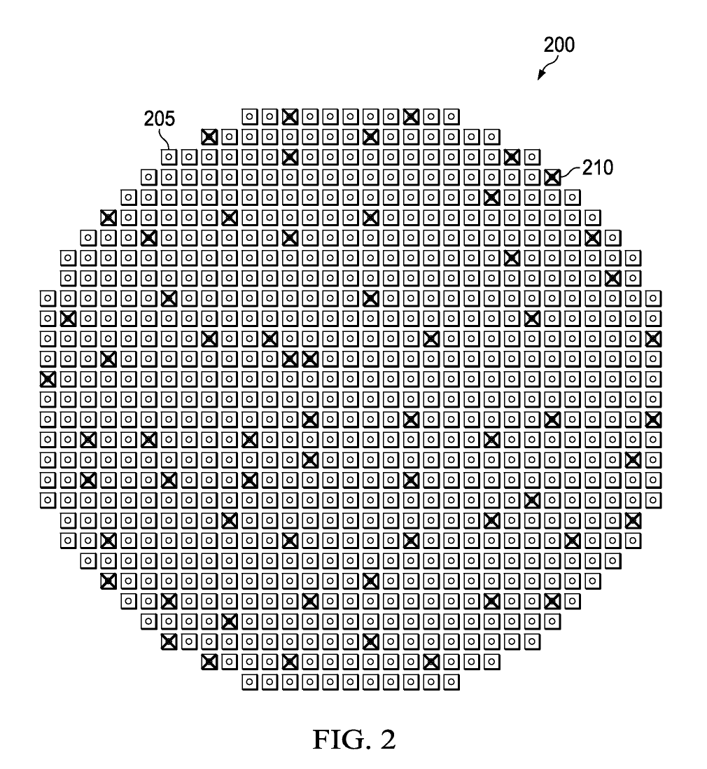

FIG. 2 is a schematic diagram of one embodiment of a wafer 200 containing “good” and “bad” chips. One “good” chip is designated 205, and one “bad” chip is designated 210. In general, “bad” chips are marked with an “X,” and “good” chips are marked with a dot at their center and lack an “X.” Several things are apparent upon inspection of the wafer 200. First, the chips are arranged in a Cartesian array. Second, the chips are generally square, meaning that separations between rows of chips are approximately the same as separations between columns of chips. Third, the wafer 200 contains a significant number of “bad” chips, on the order of 10%. An electronic wafer map corresponding to the wafer 200 may include, for example, a list of X-Y coordinates of each of the chips, both “good” and “bad,” relative to a known point (e.g., the center of the wafer) and one or more characteristics associated with each of the X-Y coordinates in the list. The characteristics may, for example, be Boolean flags indicating “good” versus “bad” or other characteristics as will be described below.

In alternative embodiments, the electronic wafer map expresses the locations of the chips in polar or other coordinates, the chips are rectangular, not arranged in rows and columns, and are of different type and therefore different dimensions.

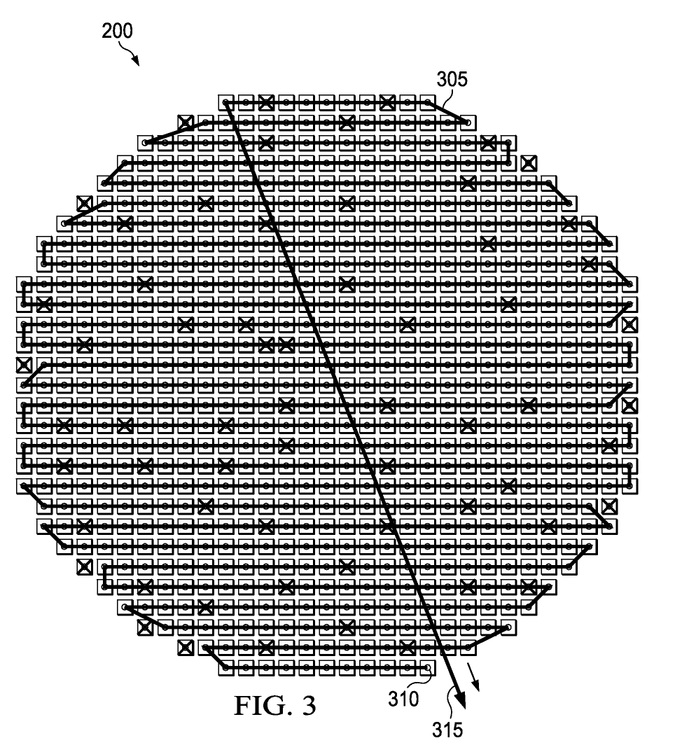

FIG. 3 is a schematic diagram of a prior art serpentine raster travel path 305 traversed by a chip selector with respect to the wafer of FIG. 2. The serpentine raster travel path 305 starts at a start point 310 and ends at an end point 315 that may be regarded as the same as the start point 310. In between the start and end points 310, 315, the serpentine raster travel path 305 traverses back-and-forth, row-by-row upward through each row as shown, traversing all of the “bad” chips except those that happen to be located at the ends of rows. While the serpentine raster travel path traverses back-and-forth along each row, it always advances from one row to the next and never reverses course to a previous row. (Of course, a serpentine raster travel path could alternatively travel row-by-row downward through each row without reversing course or travel up-and-down, column-by-column to the left or right through each column without reversing course and still be properly regarded as serpentine and raster.) Expressed in terms of units particular to one commercially-available mounter, the serpentine raster travel path 305 requires the chip selector to move 11,713.60 units relative to the wafer to depart from the start point 310 and traverse the “good” chips and a further 472.44 units to return to the end point 315.

The serpentine raster travel path 305 results in wasted movement by one or both of the table and the chip selector. A more proficient pick-and-place operation will occur if the serpentine raster travel path 305 is abandoned in favor of a non-raster travel path that results from heuristic improvement. If a heuristic analysis routine is applied to the list of coordinates that makes up an electronic wafer map and takes into account the characteristics of the chips contained in the map (e.g., disregards the “bad” chips), a shorter travel path will almost certainly result. In some embodiments, the non-raster travel path is not only shorter, but a visit to each “good” chip occurs only once, the non-raster travel path approaches the shortest possible travel path (one that achieves the well-known Held-Karp lower bound), and the non-raster travel path returns to the start point 310. In doing so, the X-Y-table expends its time and capacity positioning only to the locations of “good” chips, and circumvents “bad” chips.

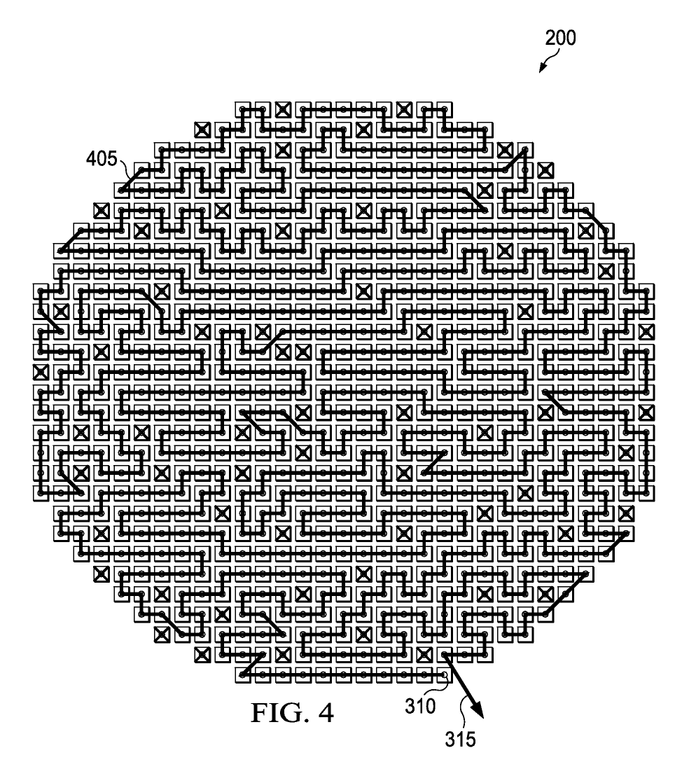

FIG. 4 is a schematic diagram of one example of a non-raster travel path 405 generated in the routing engine 140 of FIG. 1B. The non-raster travel path 405 is the result of a heuristic analysis routine. The heuristic analysis routine may include a heuristic selected from the group consisting of: (1) a nearest neighbor heuristic, (2) a greedy heuristic, (3) an insertion heuristic, (4) a Christofides heuristic, (5) a 2-opt heuristic, (6) a 3-opt heuristic, (7) a k-opt heuristic, (8) a Lin-Kernighan heuristic, (9) a tabu-search heuristic, (10) a simulated annealing heuristic and (11) a genetic heuristic. For purposes of the invention, these heuristics are equivalent, because they all can yield a travel path that is shorter than the serpentine raster travel path. Other heuristics capable of yielding a travel path that is shorter than the serpentine raster travel path fall within the broad scope of the invention and may be employed in lieu of or addition to the heuristics set forth above.

Nearest neighbor heuristics involve selecting a “good” chip near the start point, always selecting the nearest unvisited chip until no unvisited chips remain and returning to the start point. The travel paths resulting from nearest neighbor heuristics often keep their lengths to within 25% of the Held-Karp lower bound.

Greedy heuristics involve generating a list of distances separating each of the “good” chips, repeatedly selecting the shortest distance and adding it to the travel path as long as a cycle with fewer than a given number of distances does not result of any “good” chip is visited more than once. The travel paths resulting from greedy heuristics often keep their lengths to within 20% of the Held-Karp lower bound.

Insertion heuristics involve choosing a travel path that traverses only some of the “good” chips and then adding other “good” chips to the travel path according to some heuristic. The travel paths resulting from insertion heuristics often keep their lengths to around 10% over the Held-Karp lower bound.

The well-known Christofides heuristic involves constructing a minimal spanning tree (MST) traversing the “good” chips and an Euler cycle from the MST. The Euler cycle can then be analyzed to identify shortcuts that result in reductions in travel path length.

2-opt, 3-opt and, in general, k-opt, heuristics are designed to improve a travel path that has been constructed. k-opt heuristics involve removing and replacing segments (edges) from the travel path to reduce the length of the path. k designates the number of edges removed at a given time. The travel paths resulting from a k-opt heuristic often keep their lengths to within single-digit percentages over the Held-Karp lower bound.

The well-known Lin-Kernighan heuristic is a k-opt heuristic in which k varies as needed at each iteration step. See, Lin, et al., An Effective Heuristic Algorithm for the Traveling-Salesman Problem, Operations Res. 21, 498-516 (1973) and Johnson, et al., The Travelling Salesman Problem: A Case Study in Local Optimization, in Aarts, et al., editors, Local Search in Combinatorial Optimization, pages 215-310, John Wiley & Sons, Chichester, 1997, both incorporated herein by reference. The travel paths resulting from the Lin-Kernighan heuristic often keep their lengths to within 2% over the Held-Karp lower bound.

Tabu-search heuristics are also designed to improve a travel path that has already been constructed. They involve searching for nearest neighbors but avoid being trapped in local minimums by accepting increases in path length; basic neighborhood searches tend to stall in local minimums because they do not accept increases in path length.

Simulated annealing heuristics also accept increases in path length and, given sufficient iterations, provide travel paths that approach those provided by the Lin-Kernighan heuristic. Genetic heuristics involve generating multiple candidate travel paths and then mating portions of at least some of the multiple candidate travel paths in an effort to procreate travel paths having shorter path lengths.

Various embodiments of the travel path generator 150 of FIG. 1B are capable of employing one or more of the above-described heuristics, and others, to generate a non-raster travel path that improves upon the serpentine raster travel path of the prior art. It is apparent from the example of FIG. 4, that the non-raster travel path reverses course with respect to the rows it traverses, and perhaps frequently.

Expressed in terms of units particular to the above-referenced commercially-available mounter, the example non-raster travel path 405 requires the chip selector to move 10,447.00 units relative to the wafer to depart from the start point 310 and traverse the “good” chips and a further 22.6 units to return to the end point 315. This represents a path length that is shorter by 12% compared to the serpentine raster travel path 305 of FIG. 3.

The characterizations contained in the electronic wafer map are not limited to “good” and “bad” chips. In one embodiment, the wafer contains test chips, which are suitable for the purpose of testing the process by which the wafer was fabricated, but not desired to be packaged or placed on an adhesive tape strip. In such case, the electronic wafer map contains characterizations that indicate which of the chips on the wafer are test chips. For purposes of generating a non-raster travel path, the test chips may be circumvented as were the “bad” chips above.

In another embodiment, the wafer contains plural types of chips (sometimes called “zebra die”). For example, the wafer may contain chips having smaller memories and chips having larger memories. In such case, the electronic wafer map contains characterizations that indicate which of the chips on the wafer are of each type. If, for example, it is desired to mount only the chips having the smaller memories, the chips having the larger memories may be circumvented as were the “bad” chips above.

In yet another embodiment, the wafer contains plural grades of chips. For example, the wafer may contain chips that exhibit superior operating characteristics than other chips on the same wafer (e.g., commercial-grade versus industrial-grade chips). In such case, the electronic wafer map contains characterizations that indicate which of the chips on the wafer are of each grade. If, for example, it is desired to mount only the chips having the superior (e.g., commercial) grade, the chips having the inferior (e.g., industrial) grade may be circumvented as were the “bad” chips above.

In normal production, a full assembly of an entire wafer usually occurs, but in less frequent situations, partial wafer assemblies sometimes occur. For example, a situation may arise where a wafer contains an extremely large chip count, far exceeding the customer demand for the assembled product. In this event, an assembly site may elect to quarter or halve a full wafer, and assemble only the quantity needed to meet the actual demand. One embodiment of the path generation technique described herein accommodates this by establishing a new origin for each partitioned wafer segment, and re-mapping the chips with reference to the new origin. Then a non-raster travel path may be generated for “good” chips in each wafer segment as described above. Thus, the resulting non-raster travel path includes fewer than all the chips that have passed the testing.

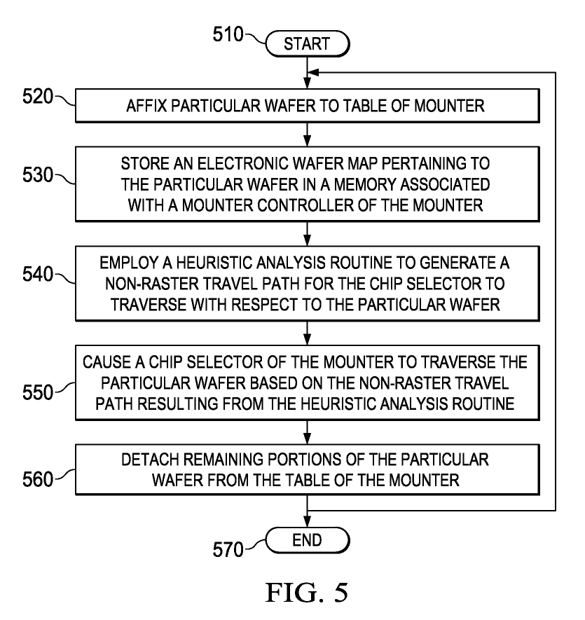

FIG. 5 is a flow diagram of one embodiment of a method of routing a chip selector of a mounter. The method begins in a start step 510. In a step 520, a particular wafer is affixed to a table of mounter. In a step 530, an electronic wafer map pertaining to the particular wafer is stored in a memory associated with a mounter controller of the mounter. In a step 540, a heuristic analysis routine is employed to generate a non-raster travel path for the chip selector to traverse with respect to the particular wafer. The non-raster travel path is shorter than a serpentine raster travel path that may have otherwise been traveled, typically traverses each chip location only once and then typically returns to its starting position. Of course, the steps 520, 530, 540 may be carried out in any order.

In a step 550, the chip selector is caused to traverse the particular wafer based on the non-raster travel path resulting from the heuristic analysis routine. In a step 560, any remaining portions of the particular wafer are detached from the table of the mounter. The method may be repeated for each wafer desired to be mounted. The method ends in an end step 570.

Those skilled in the art to which the disclosure relates will appreciate that other and further additions, deletions, substitutions and modifications may be made to the described example embodiments without departing from the disclosure.

What is claimed is:

1. A routing engine for use with a mounter having a chip selector, comprising:
a memory configured to receive and store an electronic wafer map that contains coordinates and characterizations of chips of a particular wafer; and
a travel path generator associated with said memory and configured to employ a heuristic analysis routine to generate a non-raster travel path for said chip selector to traverse with respect to said particular wafer that is shorter than a serpentine raster travel path.

2. The engine as recited in claim 1 wherein said coordinates are Cartesian coordinates.

3. The engine as recited in claim 1 wherein said heuristic analysis routine includes a heuristic selected from the group consisting of:
a nearest neighbor heuristic,
a greedy heuristic,
an insertion heuristic,
a Christofides heuristic,
a 2-opt heuristic,
a 3-opt heuristic,
a k-opt heuristic,
a Lin-Kernighan heuristic,
a tabu-search heuristic,
a simulated annealing heuristic, and
a genetic heuristic.

4. The engine as recited in claim 1 wherein said wafer contains chips that have passed testing and chips that have failed said testing and said characterizations indicate said chips that have passed said testing and said chips that have failed said testing.

5. The engine as recited in claim 4 wherein said non-raster travel path includes fewer than all said chips that have passed said testing.

6. The engine as recited in claim 1 wherein said wafer contains test chips and said characterizations indicate said test chips.

7. The engine as recited in claim 1 wherein said wafer contains plural types of chips and said characterizations indicate said types.

8. The engine as recited in claim 1 wherein said wafer contains plural grades of chips and said characterizations indicate said grades.

9. A method of routing a chip selector of a mounter, comprising:
storing an electronic wafer map in a memory, said electronic wafer map containing coordinates and characterizations of chips of a particular wafer; and
employing a heuristic analysis routine to generate a non-raster travel path for said chip selector to traverse with respect to said particular wafer that is shorter than a serpentine raster travel path.

10. The method as recited in claim 9 wherein said coordinates are Cartesian coordinates.

11. The method as recited in claim 9 wherein said heuristic analysis routine includes a heuristic selected from the group consisting of:
a nearest neighbor heuristic,
a greedy heuristic,
an insertion heuristic,
a Christofides heuristic,
a 2-opt heuristic,
a 3-opt heuristic,
a k-opt heuristic,
a Lin-Kernighan heuristic,
a tabu-search heuristic,
a simulated annealing heuristic, and
a genetic heuristic.

12. The method as recited in claim 9 wherein said wafer contains chips that have passed testing and chips that have failed said testing and said characterizations indicate said chips that have passed said testing and said chips that have failed said testing.

13. The method as recited in claim 12 wherein said non-raster travel path includes fewer than all said chips that have passed said testing.

14. The method as recited in claim 9 wherein said wafer contains test chips and said characterizations indicate said test chips.

15. The method as recited in claim 9 wherein said wafer contains plural types of chips and said characterizations indicate said types.

16. The method as recited in claim 9 wherein said wafer contains plural grades of chips and said characterizations indicate said grades.

17. A mounter, comprising:
an X-Y-table;
a table actuator coupled to said X-Y-table;
a chip selector;
a chip selector actuator coupled to said chip selector; and
a mounter controller, coupled to said table actuator and said chip selector actuator and including a routing engine, including:
a memory configured to receive and store an electronic wafer map that contains Cartesian coordinates and characterizations of chips of a particular wafer, and
a travel path generator associated with said memory and configured to employ a heuristic analysis routine to generate a non-raster travel path for said chip selector to traverse with respect to said particular wafer that is shorter than a serpentine raster travel path.

18. The mounter as recited in claim 17 wherein said heuristic analysis routine includes a heuristic selected from the group consisting of:
a nearest neighbor heuristic,
a greedy heuristic,
an insertion heuristic,
a Christofides heuristic,
a 2-opt heuristic,
a 3-opt heuristic,
a k-opt heuristic,
a Lin-Kernighan heuristic,
a tabu-search heuristic,
a simulated annealing heuristic, and
a genetic heuristic.

19. The mounter as recited in claim 17 wherein said wafer contains chips selected from the group consisting of:
chips that have passed testing,
chips that have failed said testing,
test chips,
plural types of chips, and
plural grades of chips,
and said characterizations indicate one selected from the group consisting of:
said chips that have passed said testing and said chips that have failed said testing,
said test chips,
said types, and
said grades.

20. The mounter as recited in claim 19 wherein said non-raster travel path includes fewer than all said chips that have passed said testing.
